(19) United States
(12) Patent Application Publication
(10) Pub. No.: US 2005/0111058 A1
(43) Pub. Date: May 26, 2005

(54) Scanner

(75) Inventors: Tsung-Te Lin, Taipei (TW); Ming-Wen Hong, Tainan County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/990,836

(22) Filed: Nov. 17, 2004

(30) Foreign Application Priority Data
Nov. 21, 2003 (TW) TW92220583

(51) Int. Cl. H04N 1/04

(52) U.S. Cl. 358/497; 358/474

(57) ABSTRACT

A scanner for scanning an object. The scanner includes a platen, a scanning device, a track and a base. The object is placed on the platen. The scanning device is movably disposed under the platen, for scanning the object. The base disposed on the track, flexibly maintain contact between the scanning device and the platen.

### BACKGROUND

The inventions relates to a scanner and in particular to a scanner with a contact image sensor (CIS).

FIG. 1a shows a conventional contact image sensor (CIS) scanner, which includes an upper frame 11, a lower frame 12, a platen 13, a scan head 14, a track 15 and a driving mechanism 16. The upper frame 11 has an opening 111 therein in which the platen 13 is disposed. The scan head 14 is disposed between the upper frame 11 and the lower frame 12. A contact image sensor (not shown) is recessed in the scan head 14. The contact image sensor scans the object placed on the platen 13. The track 15 is disposed in the lower frame 12. The scan head 14 has a connecting portion 141 connected to the track 15. The driving mechanism 16 moves the scan head 14 along the track 15, completing a scan of the object.

FIG. 1b shows the structure of the scanner shown in FIG. 1a. In FIG. 1b, the connecting portion 141 is formed at the bottom of the scan head 14. Several rollers 142 are installed at the top of the scan head 14 to contact the platen 13. The scan head 14 is connected to the driving mechanism 16 by a belt 161, for moving the scan head 14 along the track 15.

It may be difficult to maintain a predetermined distance between the object and the contact image sensor. Any fluctuation in mechanical dimension or change in temperature can cause deformation in material and render mass production difficult.

### SUMMARY

Therefore, an object of the present invention is to disclose a scanner that solves the above mentioned problem.

The scanner for scanning an object comprises a platen, a scanning device, a track and a base. The object is placed on the platen. The scanning device is movably disposed under the platen, scanning the object. The base based on the track, flexibly maintains contact between the scanning device and the platen.

The base comprises a body, a flexible portion and an elastic member. The body connects to the scanning device, the flexible portion is flexibly disposed on the track, and the elastic member connects the body and the flexible portion. The weight of the platen and the scanning device is exerted on the track via the body, the elastic member and the flexible portion in sequence.

The flexible portion may be a curved plate comprising a first connecting portion extended from an edge of the curved plate. The body may be a sleeve comprising a second connecting portion extended from the periphery of the sleeve. The elastic member connects the first and second connecting portions.

The flexible portion is substantially disposed in the body, and the first connecting portion protrudes from the body.

The elastic member can be a tension spring.

The scanner further comprises a contacting element disposed between the platen and the scanning device. The contacting element comprises a material with low coefficient of friction or a lubricating element. The contacting element further comprises a wear-resistant material.

The scanning device comprises a carriage and a sensor received in the carriage, movably disposed under the platen. The sensor can be a contact image sensor (CIS).

The scanner further comprises a driving mechanism for moving the scanning device along the track.

### DESCRIPTION OF THE DRAWINGS

FIG. 1a is a schematic diagram of a conventional scanner;

FIG. 1b is an enlarged view of the conventional scanner;

FIG. 2a is a schematic diagram of a scanner of the present invention;

FIG. 2b is another schematic diagram of the scanner of the present invention;

FIG. 3a is a cross section of the scanner of the present invention before a platen is attached thereon; and

FIG. 3b is a cross section of the scanner of the present invention after the platen is attached thereon.

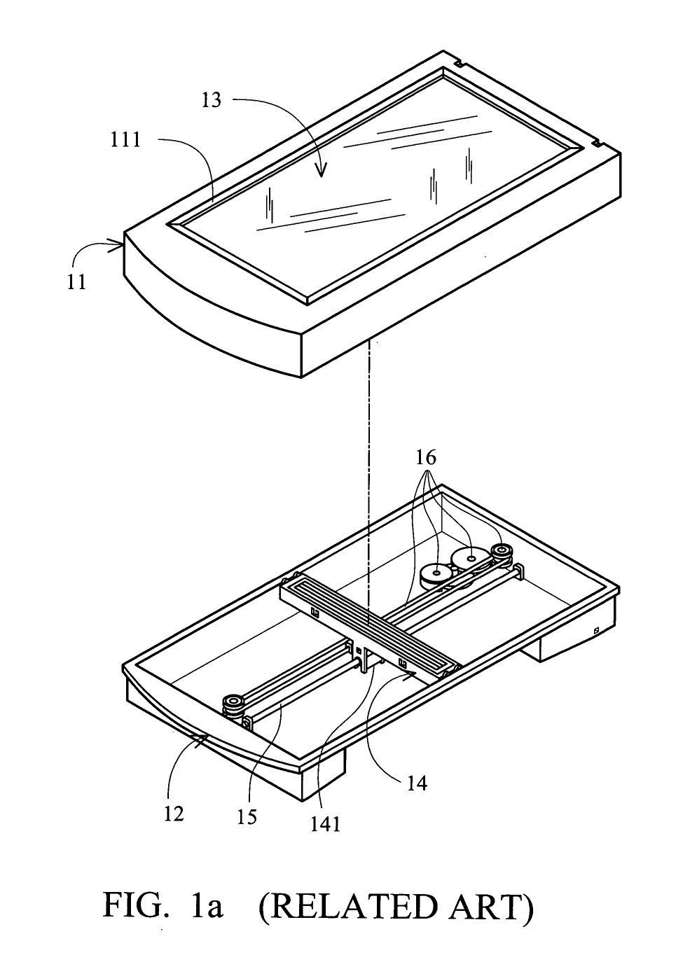

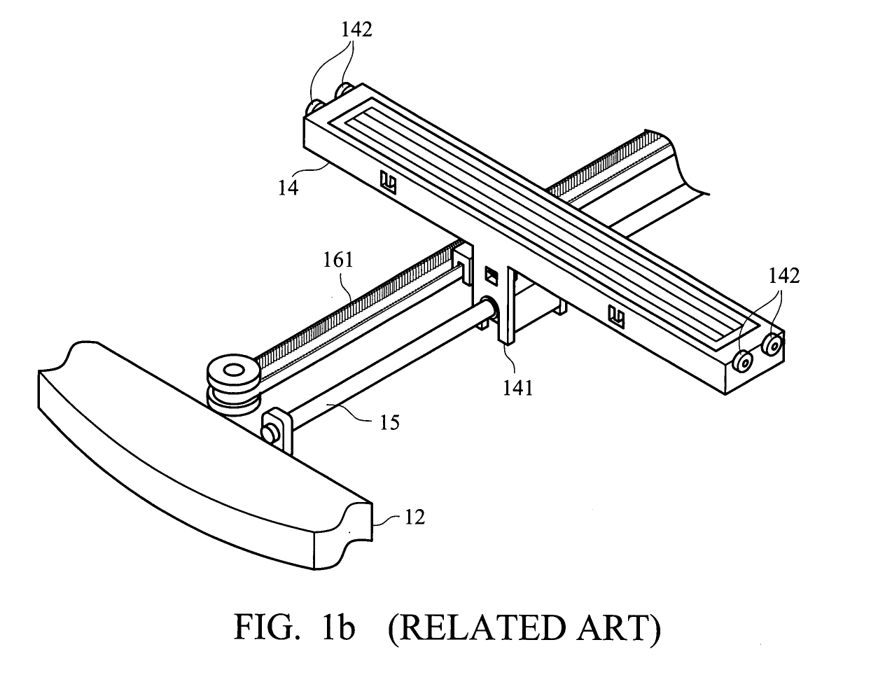

### DETAILED DESCRIPTION

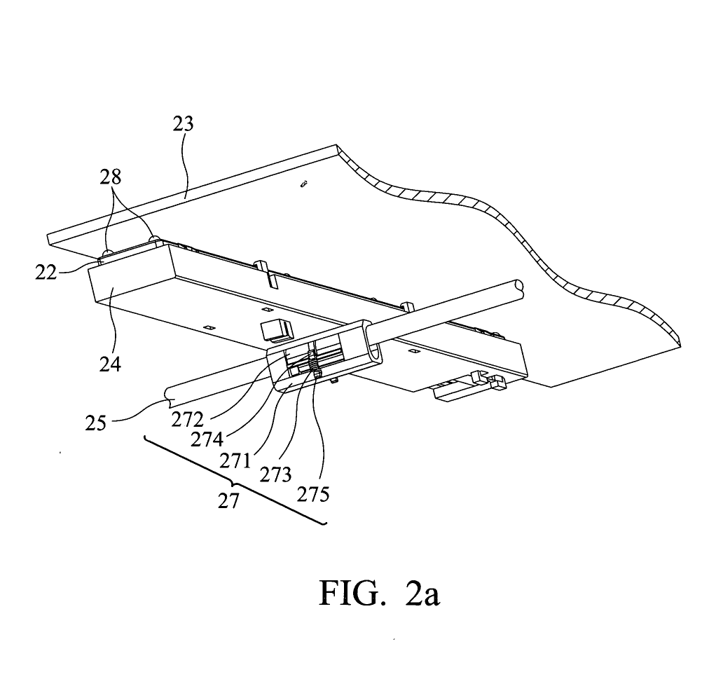

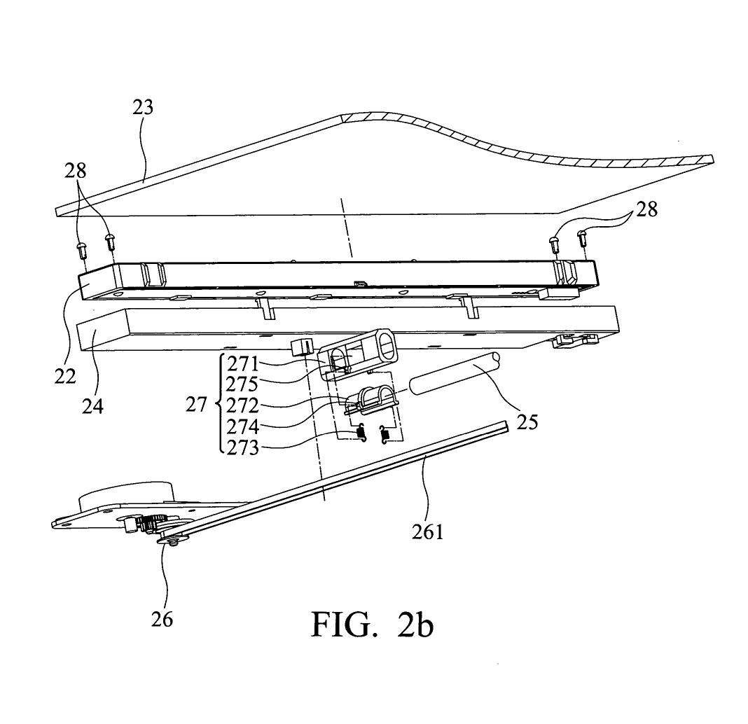

FIGS. 2a and 2b show an exemplary embodiment of a scanner. A description of devices and elements common with a conventional scanner are omitted. The scanner of the present invention comprises a platen 23, a scanning device, a track 25, and a base 27. In this embodiment, the scanning device comprises a sensor 22 and a carriage 24. The sensor 22 can be a contact image sensor (CIS).

An object such as a document or a picture is placed on the transparent platen 23. The carriage 24 is movably disposed under the platen 23 and the sensor 22 is received therein. The sensor 22 scans the object through the platen 23. Meanwhile, several contacting elements 28 are disposed on the carriage 24, contacting the platen 23. The contacting elements 28 may comprise a material with low coefficient of friction or a lubricating element or a wear-resistant material. The base 27 disposed and based on the track 25, flexibly supports the carriage 24 abutting the platen 23. A belt 261 of a driving mechanism 26 then moves the carriage 24, to complete a scan of the object.

The base 27 comprises a body 271, a flexible portion 272 and an elastic member 273. In this embodiment, the body 271 is a sleeve, the flexible portion 272 is a curved plate, and the elastic member 273 is a tension spring. The flexible portion 272 has two first connecting portions 274 extending from two ends of the curved plate. The body 271 has two second connecting portions 275 extending from two sides of the outer periphery of the sleeve. When assembled to the base 27, the flexible portion 272 is substantially disposed inside the body 271 and across the track 25 fixed in the frame. The first connecting portions 274 protrude from the body 271 corresponding to the second connecting portions 275. Two elastic members 273 then connect two pairs of the first and second connecting portions. The body 271 is fixed on the carriage 24 such that assembly of the base 27 and the carriage 24 is complete. Thus, total weight of the sensor 22, the platen 23 and the carriage 24 are exerted on the track 25 and transferred via the body 271, elastic member 273 and the flexible portion 272.

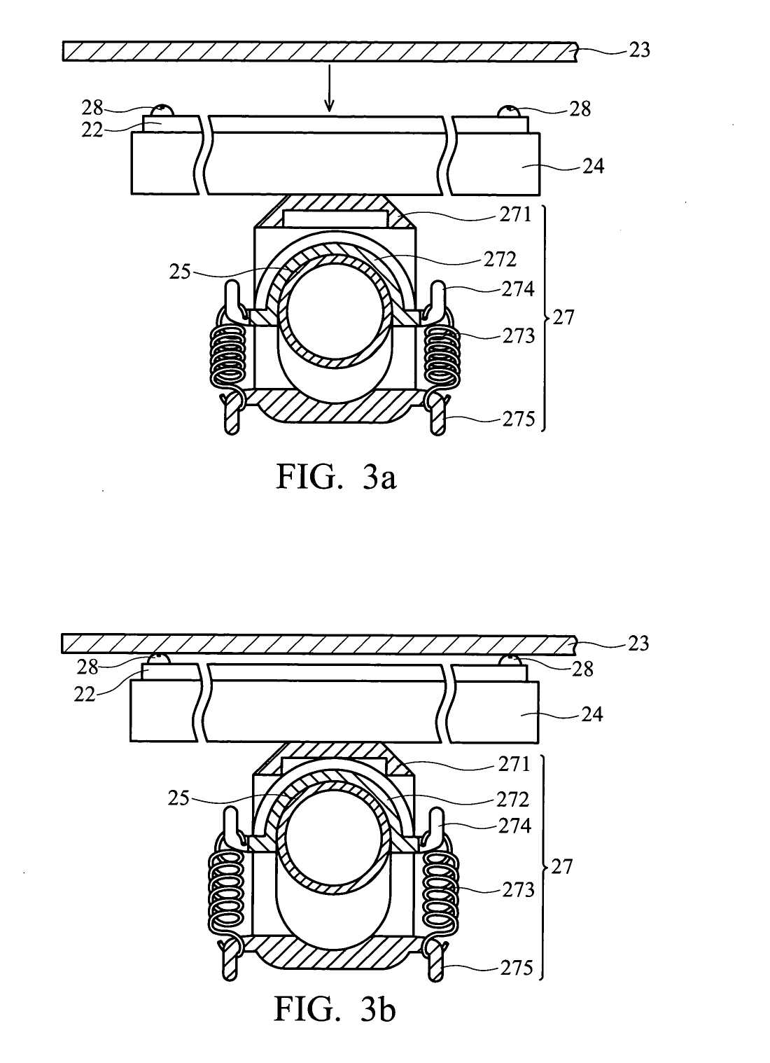

FIGS. 3a and 3b show a scanner of the present invention. FIG. 3a is a cross section of the scanner before a platen is attached thereon. FIG. 3b is a cross section of the scanner after the platen is attached thereon. The weight of the sensor 22 and the carriage 24 are exerted on the track 25 and transferred via the body 271, elastic member 273 and the flexible portion 272. Namely, the track 25 supports the sensor 22 and the carriage 24 via the base 27. At this time, the top of the contact element 28 disposed on the carriage 24 is higher than the final assembled position of the platen 23.

In FIG. 3b, when the platen 23 is installed in the direction shown by the arrow in FIG. 3a, the platen 23 pushes the contact element 28 on the carriage 24, downward on the body 271 of the base 27 connected to the carriage 24. Meanwhile, the flexible portion 272 abuts the track 25, and the track 25 is fixed in the frame of the scanner. Therefore, the body 271 moves downward, deforming the elastic member 273. Resilient force of the elastic members 273 thus pulls the second connecting portions 275 upward, and then moves the body 271 and the carriage 24 therewith toward the platen 23. Thereby, the distance between the carriage 24 and the platen 23 is secured during the scanning process. The object remains in focus for the sensor, maintaining optical quality. The driving mechanism 26 continues to drive the carriage 24 and flexible portion 272 of the base 27 along the track 25, completing the scanning process.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A scanner, comprising:
a platen;
a scanning device movably disposed under the platen;
a track; and
a base disposed on the track, flexibly supporting the scanning device abutting the platen, wherein the base comprises a body, a flexible portion and an elastic member, the body connected to the scanning device, the flexible portion disposed on the track, the elastic member connected to the body and the flexible portion, the weight of the platen and the scanning device are exerted on the track via the body, the elastic member and the flexible portion.

2. The scanner as claimed in claim 1, wherein the flexible portion is a curved plate comprising a first connecting portion extending from an edge of the curved plate, the body is a sleeve comprising a second connecting portion extending from the sleeve, and the elastic member connecting the first and second connecting portions.

3. The scanner as claimed in claim 2, wherein the flexible portion is substantially disposed in the body, and the first connecting portion protrudes from the body.

4. The scanner as claimed in claim 1, wherein the elastic member is a tension spring.

5. The scanner as claimed in claim 1, further comprising a contacting element disposed between the platen and the scanning device.

6. The scanner as claimed in claim 5, wherein the contacting element comprises a material with low coefficient of friction.

7. The scanner as claimed in claim 1, wherein the scanning device comprises a carriage and a sensor received in the carriage, movably disposed under the platen.

8. The scanner as claimed in claim 7, wherein the sensor is a contact image sensor (CIS).

9. The scanner as claimed in claim 1, further comprising a driving mechanism driving the scanning device along the track.
